(19) United States
(12) Patent Application Publication
(10) Pub. No.: US 2025/0262789 A1
(43) Pub. Date: Aug. 21, 2025

(54) METHOD OF MANUFACTURING INFUSION BAG

(71) Applicant: FUJIFILM Corporation, Tokyo (JP)

(72) Inventor: Yoshiki SAKAZAKI, Minamiashigara-shi (JP)

(73) Assignee: FUJIFILM Corporation, Tokyo (JP)

(21) Appl. No.: 19/199,576

(22) Filed: May 6, 2025

Related U.S. Application Data
(63) Continuation of application No. PCT/JP2023/044076, filed on Dec. 8, 2023.

(30) Foreign Application Priority Data
Dec. 23, 2022 (JP) 2022-206335

(51) Int. Cl. B26F 1/02; A61J 1/10

(52) U.S. Cl. CPC B26F 1/02; A61J 1/10

(57) ABSTRACT

An object is to provide a method of manufacturing an infusion bag where a first barrier film including an organic layer/inorganic layer laminated barrier layer is bonded to one surface and a second barrier film including a metal barrier layer is bonded to the other surface, the method being capable of stably manufacturing an infusion bag where an appropriate inorganic layer is provided and outward exposure of an edge of the metal layer is suppressed. In the method, in a punched portion of the infusion bag, a first barrier film, a first sealant layer, an infusion bag layer, a second sealant layer, and a second barrier film are laminated in this order, and in a state where a surface on the second barrier film side is mounted in contact with a support table for punching, the infusion bag is punched by allowing a blade to cut into the infusion bag from the first barrier film. Thus, the object is achieved.

### CROSS-REFERENCE TO RELATED APPLICATIONS

This application is a Continuation of PCT International Application No. PCT/JP2023/044076 filed on Dec. 8, 2023, which claims priority under 35 U.S.C. § 119(a) to Japanese Patent Application No. 2022-206335 filed on Dec. 23, 2022. The above applications are hereby expressly incorporated by reference, in their entirety, into the present application.

### BACKGROUND OF THE INVENTION

### 1. Field of the Invention

The present invention relates to a method of manufacturing an infusion bag. Specifically, the present invention relates to a method of manufacturing an infusion bag where a barrier film is bonded to both surfaces to prevent deterioration of the content caused by water or the like.

### 2. Description of the Related Art

An infusion bag for accommodating a drug that is denatured by water or oxygen is required to have high gas barrier properties from the viewpoint of improving storage stability of a drug or the like.

Accordingly, in the infusion bag that is required to have gas barrier properties, the gas barrier properties are improved by bonding a barrier film (gas barrier film) to the surface.

As the barrier film having high gas barrier properties, there is known a barrier film including a laminated barrier layer where an organic layer and an inorganic layer are laminated, the laminated barrier layer including one or more combinations of an inorganic layer that exhibits gas barrier properties and an organic layer that is an underlying layer of the inorganic layer on a support such as a resin film.

JP2012-075716A describes an infusion bag to which a barrier film including the laminated barrier layer is bonded.

Specifically, JP2012-075716A discloses an infusion bag including: a bag consisting of a resin film including polyethylene and/or polypropylene; and a barrier layer provided on at least one surface of the bag, in which the barrier layer has a structure in which a first organic layer, an inorganic layer, and a second organic layer mutually adjoin in this order.

In the infusion bag described in JP2012-075716A, as the barrier film where the barrier layer is provided on the support (plastic film), a sealant layer consisting of the same resin film as that of the resin bag is bonded to the barrier film, and the sealant layer is heat-scaled to the resin bag to bond the barrier film to the infusion bag.

Specifically, in the infusion bag described in JP2012-075716A, a laminated film is prepared, the laminated film including the barrier film, an adhesive, and the sealant layer, in which the sealant layer adheres to the second organic layer of the barrier film through the adhesive. By heat-sealing the sealant layer of the laminated film to the resin bag, the barrier film is bonded to the infusion bag.

Further, as the infusion bag where the barrier film is bonded to both surfaces, the use of a barrier film including a metal layer (metal foil) such as aluminum foil as a barrier layer on one surface is known (refer to JP2015-080871A).

Regarding the barrier film including the laminated barrier layer where the organic layer and the inorganic layer are laminated, by selecting a material for forming the inorganic layer, a barrier film having not only gas barrier properties but also excellent transparency can be obtained.

Accordingly, by using the barrier film including the laminated barrier layer having excellent transparency, the content of the infusion bag is visible.

Here, in a case where the barrier film is bonded to one surface of the infusion bag, it is preferable that a sheet having bend resistance is bonded to the opposite side. Correspondingly, as described in JP2015-080871A, the barrier film including the laminated barrier layer having excellent transparency is bonded to one surface, and the barrier film having a metal thin film such as aluminum foil is bonded to the other surface. In addition, this way, in a case where one surface is a light-transmitting surface, by using a homogeneous non-light-transmitting surface for the other surface, a dissolved state of a powder drug is likely to be verified.

### SUMMARY OF THE INVENTION

In the infusion bag where the barrier film including the laminated barrier layer is bonded, in order for the barrier film to exhibit desired gas barrier properties, it is important that cracking, breakage, peeling, and the like do not occur in the inorganic layer that exhibits gas barrier properties.

In addition, in the infusion bag formed of the barrier film including the metal layer as the barrier layer, in a case where an edge of the metal layer is exposed outward, a handler of the infusion bag such as a nurse may be injured by the edge of the metal layer. Accordingly, in the infusion bag formed of the barrier film including the metal layer, the edge of the metal layer needs to be prevented from being exposed outward.

An object of the present invention is to provide a method of manufacturing an infusion bag in which, in order to prevent the content from deteriorating due to water or the like, a barrier film including a laminated barrier layer where an organic layer and an inorganic layer are laminated is bonded to one surface and a barrier film formed of a metal layer as a barrier layer is bonded to the other surface, the method being capable of stably manufacturing an infusion bag where an appropriate inorganic layer is provided and outward exposure of an edge of the metal layer is suppressed.

In order to achieve the object, the present invention has the following configurations.

[1] A method of manufacturing an infusion bag, the method comprising:
punching an infusion bag where a barrier film is bonded to both surfaces of an infusion bag body through a sealant layer,
in which in a punched portion of the infusion bag, a first barrier film, a first sealant layer, an infusion bag layer, a second sealant layer, and a second barrier film are laminated in this order,
the first barrier film includes a metal layer as a barrier layer, and the second barrier film includes a laminated barrier layer having a configuration where an organic layer and an inorganic layer are laminated, and
in a state where the punched portion of the infusion bag is mounted on a support table for punching such that a surface on the second barrier film side is in contact with the support table for punching, the infusion bag is punched by allowing a blade to cut into the infusion bag in a direction from the first barrier film toward the second barrier film side.

[2] The method of manufacturing an infusion bag according to [1],
in which the first barrier film includes a support and a metal layer having a thickness of 50 μm or less that is laminated on the support.

[3] The method of manufacturing an infusion bag according to [1] or [2],
in which the metal layer of the first barrier film is an aluminum layer.

[4] The method of manufacturing an infusion bag according to any one of [1] to [3],
in which a total thickness of the first sealant layer, the infusion bag layer, and the second sealant layer is 50 μm or more.

[5] The method of manufacturing an infusion bag according to any one of [1] to [4],
in which a material for forming the first sealant layer, the infusion bag layer, and the second sealant layer is any one of polypropylene, polyethylene, or polyvinyl chloride.

[6] The method of manufacturing an infusion bag according to any one of [1] to [5],
in which the second barrier film includes a support and the laminated barrier layer that is laminated on the support.

[7] The method of manufacturing an infusion bag according to [6],
in which the support is a polyethylene terephthalate film.

[8] The method of manufacturing an infusion bag according to [6] or [7],
in which a thickness of the support is 50 μm or more.

[9] The method of manufacturing an infusion bag according to any one of [1] to [8],
in which the laminated barrier layer includes one or more laminated structures of an underlying organic layer and an inorganic layer and a protective organic layer that is an upper most layer.

According to the present invention, it is possible to provide a method of manufacturing an infusion bag in which, in order to prevent the content from deteriorating due to water or the like, a barrier film including a laminated barrier layer where an organic layer and an inorganic layer are laminated is bonded to one surface and a barrier film formed of a metal layer as a barrier layer is bonded to the other surface, the method being capable of stably manufacturing an infusion bag where an appropriate inorganic layer is provided and outward exposure of an edge of the metal layer is suppressed.

### BRIEF DESCRIPTION OF THE DRAWINGS

FIG. 1 is a diagram conceptually showing an example of an infusion bag on which a method of manufacturing an infusion bag according to the present invention is performed.

FIG. 2 is a partially enlarged view of FIG. 1.

FIG. 3 is a conceptual diagram showing the method of manufacturing an infusion bag according to the present invention.

FIG. 4 is a diagram conceptually showing a punched portion of the infusion bag that is punched by the method of manufacturing an infusion bag according to the present invention.

FIG. 5 is a conceptual diagram showing a method of manufacturing an infusion bag in the related art.

FIG. 6 is a diagram conceptually showing a punched portion of an infusion bag that is punched by the method of manufacturing an infusion bag shown in FIG. 5.

### DESCRIPTION OF THE PREFERRED EMBODIMENTS

Hereinafter, a method of manufacturing an infusion bag according to an embodiment of the present invention will be described in detail based on preferred examples shown in the accompanying drawings.

In the present invention, numerical ranges represented by “to” include numerical values before and after “to” as lower limit values and upper limit values.

Further, all the drawings described below are conceptual views for describing the present invention. Accordingly, a size, a thickness, a shape, a positional relationship, and the like of each of members are different from the actual ones.

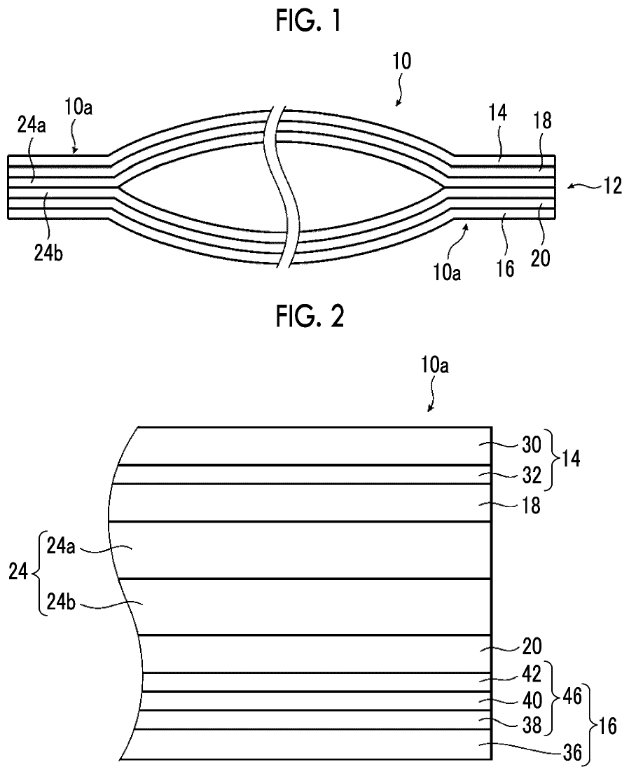

FIG. 1 is a diagram conceptually showing an example of an infusion bag on which the method of manufacturing an infusion bag according to the embodiment of the present invention is performed. An infusion bag 10 shown in FIG. 1 is punched using the method of manufacturing an infusion bag according to the embodiment of the present invention to be processed into a shape of a product.

As shown in FIG. 1, the infusion bag 10 on which the manufacturing method according to the embodiment of the present invention is performed includes an infusion bag body 12, a first barrier film 14, a second barrier film 16, a first sealant layer 18, and a second sealant layer 20.

The infusion bag body 12 is a bag body forming a well-known infusion bag for a medical use where edge parts of two laminated resin films including a first resin film 24a and a second resin film 24b are bonded and sealed.

In the following description, in the infusion bag 10, a portion corresponding to a bonded portion of the first resin film 24a and the second resin film 24b in the edge part of the infusion bag body 12 will also be referred to as a sealed portion 10a for convenience of description. In the manufacturing method according to the embodiment of the present invention, this sealed portion 10a is the punched portion of the infusion bag 10.

The first barrier film 14 is heat-sealed to one surface of the infusion bag body 12 through the first sealant layer 18. On the other hand, the second barrier film 16 is heat-sealed to the other surface of the infusion bag body 12 through the second sealant layer 20.

In the infusion bag 10 according to the embodiment of the present invention, the first barrier film 14 includes a metal layer as a barrier layer.

On the other hand, the second barrier film 16 includes a laminated barrier layer having a structure where an organic layer and an inorganic layer are laminated.

FIG. 2 conceptually shows the sealed portion 10a of the infusion bag 10.

In the sealed portion 10a, the first resin film 24a and the second resin film 24b forming the infusion bag body 12 are bonded to each other to form an infusion bag layer 24.

The first barrier film 14 is heat-sealed to one surface of the infusion bag layer 24 through the first sealant layer 18, and the second barrier film 16 is heat-sealed to the other surface of the infusion bag layer 24 through the second sealant layer 20.

In the infusion bag 10 in the example shown in the drawing, in the first barrier film 14, a metal layer 32 is laminated on a support 30.

On the other hand, in the second barrier film 16, a laminated barrier layer 46 where an underlying organic layer 38, an inorganic layer 40, and a protective organic layer 42 are laminated is laminated on a support 36.

In the infusion bag 10 on which the manufacturing method according to the embodiment of the present invention is performed, as described above, the infusion bag body 12 is a bag body forming a well-known infusion bag for a medical use where edge parts of the two laminated resin films including the first resin film 24a and the second resin film 24b that have the same shape are bonded and sealed.

The shape (planar shape) of the infusion bag body 12, that is, the first resin film 24a and the second resin film 24b is typically a rectangular shape.

In addition, as a method of bonding and sealing the first resin film 24a and the second resin film 24b in the sealed portion 10a, a well-known method can be used, and examples thereof include adhesion by an adhesive and heat sealing.

As the first resin film 24a and the second resin film 24b, a heat sealable (thermally fusible) film is suitably used.

Examples of the first resin film 24a and the second resin film 24b include a film consisting of polyolefin such as polyethylene (PE) or polypropylene (PP) and a film consisting of polyvinyl chloride.

The thickness of the first resin film 24a and the second resin film 24b forming the infusion bag body 12 is not limited, and may be appropriately set depending on the size of the infusion bag 10, the kind of the content, and the like such that a sufficient strength as a bag body for accommodating the content can be obtained.

The thickness of the first resin film 24a and the second resin film 24b is typically 50 to 500 μm and preferably 150 to 250 μm.

As described above, in the first barrier film 14, the metal layer 32 is laminated on the support 30. In the first barrier film 14 the metal layer 32 acts as a barrier layer.

As the first barrier film 14, various well-known laminates where a metal layer is laminated on a support that are used as a barrier film (gas barrier film) can be used.

In the first barrier film 14, the support 30 supports the metal layer 32. The support 30 is not particularly limited, and various well-known sheet-shaped materials (plate-shaped materials, films, or layers) can be used.

As the support 30, for example, a sheet consisting of a resin material is suitably used.

Examples of the resin material for forming the support 30 include polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), an acrylonitrile-butadiene-styrene copolymer (ABS), a cycloolefin copolymer (COC), a cycloolefin polymer (COP), triacetyl cellulose (TAC), an ethylene-vinyl alcohol copolymer (EVOH), and nylon.

The thickness of the support 30 is not limited, and may be appropriately set depending on the forming material such that the metal layer 32 can be supported. The thickness of the support 30 is preferably 50 to 150 μm and more preferably 75 to 100 μm.

The thickness of the support 30 is preferably 50 μm or more from the viewpoints that, for example, the strength of the first barrier film 14 can be ensured, wrinkles of the sealed portion formed by heat sealing can be suppressed, and a load bearing strength during formation of a hanging hole of the infusion bag can be ensured.

The thickness of the support 30 is preferably 150 μm or less from the viewpoint that, for example, a strength required for communication during dissolution just before use can be reduced.

The metal layer 32 is laminated on the support 30.

The metal layer 32 is not limited, and various well-known metal layers (metal barrier layers) that can be used as a barrier layer for a barrier film (gas barrier film) can be used.

Examples of the metal layer 32 include metal layers consisting of aluminum, magnesium, or an alloy including the above-described metal as a major component. In particular, for example, a metal layer consisting of aluminum or an alloy including aluminum as a major component can be suitably used.

In the first barrier film 14, the thickness of the metal layer 32 is not limited, and may be appropriately set depending on a liquid material of the metal layer 32 such that the metal layer 32 can act as a barrier layer.

The thickness of the metal layer 32 is preferably 50 μm or less.

The thickness of the metal layer 32 is preferably 50 μm or less from the viewpoints that, for example, outward exposure of an edge of the metal layer can be suitably prevented, the flexibility of the infusion bag can be ensured to facilitate communication for dissolution just before use, punchability described below can be improved, and flexibility required for handling as a sheet during manufacturing can be ensured.

The thickness of the metal layer 32 is more preferably 30 μm or less and still more preferably 15 μm or less.

On the other hand, in a case where the metal layer 32 is excessively thin, there may be an inconvenience in that, for example, sufficient gas barrier properties cannot be obtained or pinholes are formed.

In consideration of this point, the thickness of the metal layer 32 is preferably 5 μm or more and more preferably 10 μm or more.

As described above, as the first barrier film 14, various well-known barrier films where the metal layer 32 as the barrier layer is laminated on the support 30 that can be used as a barrier film can be used.

Accordingly, in the first barrier film 14, the metal layer 32 may be directly formed and laminated on the support 30 using a plating method such as melt plating or electroless plating or a vacuum film forming method (vacuum deposition method) such as vapor deposition, CVD, plasma CVD, or sputtering. Alternatively, in the first barrier film 14, a metal film (metal foil) may be bonded to the support 30 using a bonding agent corresponding to the forming material to form the metal layer 32.

In addition, as the first barrier film 14, a commercially available product can also be suitably used.

On the other hand, in the second barrier film 16, the laminated barrier layer 46 is laminated on the resin film for forming the support 36.

The laminated barrier layer 46 is a laminated barrier layer where an organic layer and an inorganic layer are laminated, the laminated barrier layer including the underlying organic layer 38, the inorganic layer 40, and the protective organic layer 42 in this order from the support 36 side.

The laminated barrier layer 46 in the example shown in the drawing includes only one laminated structure of the underlying organic layer 38 and the inorganic layer 40, but the present invention is not limited thereto.

For example, in the infusion bag manufactured using the manufacturing method according to the embodiment of the present invention, the laminated barrier layer may include two laminated structures of the underlying organic layer 38 and the inorganic layer 40, the two laminated structures including the underlying organic layer 38, the inorganic layer 40, the underlying organic layer 38, and the inorganic layer 40 in this order from the support 36 side. In addition, the laminated barrier layer may include three laminated structures of the underlying organic layer 38 and the inorganic layer 40, the three laminated structures including the underlying organic layer 38, the inorganic layer 40, the underlying organic layer 38, the inorganic layer 40, the underlying organic layer 38, and the inorganic layer 40 in this order from the support 36 side. Further, the laminated barrier layer may include four or more laminated structures of the underlying organic layer 38 and the inorganic layer 40.

That is, in the infusion bag manufactured using the manufacturing method according to the embodiment of the present invention, the laminated barrier layer in the second barrier film 16 can adopt various layer configurations as long as it includes one or more laminated structures of the underlying organic layer 38 and the inorganic layer 40 and preferably includes the protective organic layer 42 as the upper most layer.

In the present invention, the support 36 supports the laminated barrier layer 46, and a well-known sheet-shaped material (a film or a plate-shaped material) that is used as a support for various barrier films, various laminated functional films, and the like can be used.

A material of the support 36 of the second barrier film 16 is not limited, and various materials can be used as long as the underlying organic layer 38 and the inorganic layer 40 can be formed.

As the support 36, for example, a resin film is suitably used. Specifically, the resin film consisting of the resin material described above as the example of the support 30 of the first barrier film 14 can be used. In particular, a PET film is suitably used.

The thickness of the support 36 is not limited and may be appropriately set depending on the forming material such that the laminated barrier layer 46 can be supported, the mechanical strength of the second barrier film 16 can be sufficiently ensured, and sufficient flexibility can be obtained.

In the manufacturing method according to the embodiment of the present invention, the thickness of the support 36 of the second barrier film 16 is preferably 50 μm or more. The support 36 also acts as a protective layer of the inorganic layer 40. Accordingly, by adjusting the thickness of the support 36 to be 50 μm or more, damage of the inorganic layer 40 can be suitably prevented.

Further, the thickness of the support 36 is preferably 50 μm or more from the viewpoint that, for example, stiffness for preventing deformation such as nicks having a small bending radius can be ensured such that the occurrence of damage caused by handing during or after manufacturing a product can be suppressed.

The thickness of the support 36 of the second barrier film 16 is more preferably 80 μm or more and still more preferably 100 μm or more.

On the other hand, in a case where the support 36 is excessively thick, there may be an inconvenience in that, for example, the flexibility of the second barrier film 16 decreases, the second barrier film 16 is unnecessarily thick, a strength required for communication increases such that communication is difficult, and a large force is required for punching described below.

In consideration of this point, the thickness of the support 36 of the second barrier film 16 is preferably 150 μm or less.

In the second barrier film 16, the underlying organic layer 38 is formed on one surface of the support 36.

The underlying organic layer 38 consists of, for example, an organic compound obtained by polymerization (crosslinking or curing) of a monomer, a dimer, an oligomer, or the like.

The underlayer of the inorganic layer 40, that is, the underlying organic layer 38 functioning as the formation surface of the inorganic layer 40 is an underlayer for appropriately forming the inorganic layer 40.

The underlying organic layer 38 formed on the surface of the support 36 embeds unevenness of the surface of the support 36, foreign matter attached to the surface, and the like to appropriately planarize the formation surface of the inorganic layer 40 such that the inorganic layer 40 can be appropriately formed.

As described above, in the present invention, the gas barrier layer may include a plurality of laminated structures of the inorganic layer 40 and the underlying organic layer 38. In this case, the second or subsequent underlying organic layer 38 is formed on the inorganic layer 40. Even in this configuration, the underlying organic layer 38 functioning as the underlayer of the inorganic layer 40 exhibits the same action. That is, the underlayer of the inorganic layer 40 is the formation surface of the inorganic layer 40.

In particular, by providing the underlying organic layer 38 on the surface of the support 36, the inorganic layer 40 that mainly exhibits gas barrier properties can be appropriately formed.

The underlying organic layer 38 is formed, for example, by curing a composition for forming an organic layer that includes an organic compound (a monomer, a dimer, a trimer, an oligomer, a polymer, and the like). The composition for forming an organic layer may include one kind or two or more kinds of organic compounds.

The underlying organic layer 38 includes, for example, a thermoplastic resin and an organic silicon compound. Examples of the thermoplastic resin include polyester, a (meth)acrylic resin, a methacrylic acid-maleic acid copolymer, polystyrene, a transparent fluororesin, polyimide, fluorinated polyimide, polyamide, polyamide imide, polyether imide, cellulose acylate, polyurethane, polyether ether ketone, polycarbonate, an alicyclic polyolefin, polyarylate, polyethersulfone, polysulfone, fluorene ring-modified polycarbonate, alicyclic-modified polycarbonate, fluorene ring-modified polyester, and an acrylic compound. Examples of the organic silicon compound include polysiloxane.

It is more preferable that the underlying organic layer 38 includes a (meth)acrylic resin including, as a major component, a monomer, a dimer, an oligomer, or the like of a bi- or higher functional (meth)acrylate such as dipropylene glycol di(meth)acrylate (DPGDA), trimethylolpropane tri(meth)acrylate (TMPTA), or dipentaerythritol hexa(meth)acrylate (DPHA), and it is still more preferable that the underlying organic layer 38 includes a (meth)acrylic resin including, as a major component, a polymer of a monomer or a polymer such as a dimer, an oligomer of a tri- or higher functional (meth)acrylate. In addition, a plurality of (meth)acrylic resins may be used. The major component refers to a component having the highest content mass ratio among components included.

It is preferable that the composition for forming an organic layer includes an organic solvent, a surfactant, and a silane coupling agent in addition to the organic compound.

In a case where a plurality of underlying organic layers 38 are provided, that is, in a case where plural sets of combinations of the underlying organic layers 38 and the inorganic layers 40 are provided as described above, the materials of the underlying organic layers 38 may be the same as or different from each other.

The thickness of the underlying organic layer 38 is not limited and can be appropriately set according to components in the composition for forming an organic layer, the support 36 used, and the like.

The thickness of the underlying organic layer 38 is preferably 0.1 to 5 μm and more preferably 0.2 to 3 μm. It is preferable that the thickness of the underlying organic layer 38 is 0.1 μm or more from the viewpoint of embedding unevenness of the surface of the support 36, foreign matter attached to the surface, and the like such that the surface of the underlying organic layer 38 can be planarized. It is preferable that the thickness of the underlying organic layer 38 is 5 μm or less from the viewpoints that, for example, cracks of the underlying organic layer 38 can be prevented, the flexibility of the barrier film can be improved, and the thickness and weight of the barrier film can be reduced.

In a case where a plurality of underlying organic layers 38 are provided, that is, a case where plural sets of combinations of the inorganic layers 40 and the underlying organic layers 38 are provided, the thicknesses of the respective underlying organic layers 38 may be the same as or different from each other.

The underlying organic layer 38 can be formed with a well-known method depending on materials.

For example, the underlying organic layer 38 can be formed with a coating method of applying the above-described composition for forming an organic layer and drying the composition for forming an organic layer. During the formation of the underlying organic layer 38 with the coating method, the dried composition for forming an organic layer is irradiated with ultraviolet rays to polymerize (crosslink) the organic compound in the composition for forming an organic layer.

The inorganic layer 40 is a thin film including an inorganic compound, and is provided on a surface of the underlying organic layer 38. In the second barrier film 16, the inorganic layer 40 mainly exhibits gas barrier properties.

The surface of the support 36 includes a region such as unevenness or shadow of foreign matter to which the inorganic compound is not likely to adhere. By providing the underlying organic layer 38 and forming the inorganic layer 40 thereon, the region to which the inorganic compound is not likely to adhere is covered. Therefore, the inorganic layer 40 can be formed on the formation surface of the inorganic layer 40 without a gap.

A material of the inorganic layer 40 is not limited, and various inorganic compounds that are used for a well-known gas barrier layer consisting of an inorganic compound exhibiting gas barrier properties can be used.

Examples of a material of the inorganic layer 40 include inorganic compounds, for example, a metal oxide such as aluminum oxide, magnesium oxide, tantalum oxide, zirconium oxide, titanium oxide, or indium tin oxide (ITO); a metal nitride such as aluminum nitride; a metal carbide such as aluminum carbide; a silicon oxide such as silicon oxide, silicon oxynitride, silicon oxycarbide, or silicon oxynitride-carbide; a silicon nitride such as silicon nitride or silicon nitride-carbide; a silicon carbide such as silicon carbide; a hydride thereof; a mixture of two or more kinds thereof; and a hydrogen-containing material thereof. In addition, a mixture of two or more kinds of the examples can be used.

In particular, silicon nitride, silicon oxide, silicon oxynitride, aluminum oxide, or a mixture of two or more kinds thereof is preferably used from the viewpoints that transparency is high and excellent gas barrier properties can be exhibited. In particular, a compound including silicon is preferably used, and silicon nitride is more preferably used from the viewpoint that excellent gas barrier properties can be exhibited.

The thickness of the inorganic layer 40 is not particularly limited and can be appropriately set depending on materials such that desired gas barrier properties can be exhibited.

The thickness of the inorganic layer 40 is preferably 10 to 150 nm, more preferably 12 to 100 nm, and still more preferably 15 to 75 nm.

It is preferable that the thickness of the inorganic layer 40 is 10 nm or more from the viewpoint that the inorganic layer 40 stably exhibiting sufficient gas barrier performance can be formed. In addition, in a case where the inorganic layer 40 is generally brittle and is excessively thick, breakage, cracking, peeling, or the like may occur. However, by adjusting the thickness of the inorganic layer 40 to be 150 nm or less, the occurrence of breakage can be suppressed.

As described above, in a case where a plurality of inorganic layers 40 are provided, the thicknesses of the inorganic layers 40 may be the same as or different from each other.

In addition, in a case where a plurality of inorganic layers 40 are provided, the materials of the inorganic layers 40 may be the same as or different from each other.

The inorganic layer 40 can be formed with a well-known method depending on materials.

For example, plasma CVD such as capacitively coupled plasma (CCP)-chemical vapor deposition (CVD) or inductively coupled plasma (ICP)-CVD, atomic layer deposition (ALD), sputtering such as magnetron sputtering or reactive sputtering, or various vapor deposition methods such as vacuum deposition can be suitably used.

The protective organic layer 42 is provided as a preferable aspect, and is a layer for protecting the inorganic layer 40 consisting of an organic material. By providing the protective organic layer 42 as the upper most layer of one or more sets of laminated structures of the underlying organic layer 38 and the inorganic layer 40, breakage or the like of the inorganic layer 40 can be prevented.

A material for forming the protective organic layer 42 is not particularly limited, and various well-known organic compounds can be used as in the above-described underlying organic layer 38.

In addition, as the material for forming the protective organic layer 42, a urethane skeleton acrylate polymer such as a polymerizable composition for forming a second organic layer described in paragraphs [0016] to [0027] of JP2015-171798A may be used. In addition, the composition for forming the protective organic layer 42 may include an additive such as a monomer, an oligomer, or a polymer, a polymerization initiator, and a silane coupling agent, in addition to the urethane skeleton acrylate polymer.

The thickness of the protective organic layer 42 may be appropriately set depending on the material for forming the protective organic layer 42, the inorganic layer 40, and the like. According to an investigation by the present inventors, the thickness of the protective organic layer 42 is preferably 0.1 to 50 μm, more preferably 0.5 to 25 μm, and still more preferably 1 to 10 μm. By adjusting the thickness of the protective organic layer 42 to be 0.1 μm or more, the inorganic layer 40 can be appropriately protected. In addition, by adjusting the thickness of the protective organic layer 42 to be 50 μm or less, the thickness of the barrier film can be reduced.

For example, as in the underlying organic layer 38, the protective organic layer 42 can be formed with a coating method of applying a composition for forming an organic layer including an organic compound for forming the protective organic layer 42 and drying the composition for forming an organic layer.

As described above, the first barrier film 14 is bonded to one surface of the infusion bag body 12 through the first sealant layer 18. On the other hand, the second barrier film 16 is bonded to the other surface of the infusion bag body 12 through the second sealant layer 20.

Both of the first sealant layer 18 and the second sealant layer 20 bond the first barrier film 14 and the second barrier film 16 to the infusion bag body 12 by heat sealing.

In the following description, in a case where it is not necessary to distinguish between the first sealant layer 18 and the second sealant layer 20, both of the first sealant layer 18 and the second sealant layer 20 will also be referred to as “sealant layer”.

Basically, the sealant layer is formed of the same forming material as that of the infusion bag body 12, that is, the first resin film 24a and the second resin film 24b.

Accordingly, in a case where the infusion bag body 12 is formed of polyethylene (PE), a sheet-shaped material formed of PE is used as the sealant layer, and in a case where the infusion bag body 12 is formed of polypropylene (PP), a sheet-shaped material formed of PP is used as the sealant layer.

As described above, as the first resin film 24a and the second resin film 24b, PE, PP, or polyvinyl chloride is suitably used. Accordingly, likewise, as the sealant layer, PE, PP, or polyvinyl chloride is suitably used.

In addition, the thickness of the sealant layer is not also limited, and may be appropriately selected depending on the material for forming the sealant layer and the shape, state, or the like of the object such as an infusion bag to be heat-sealed such that the object can be reliably heat-sealed.

Here, in the method of manufacturing the infusion bag 10 according to the embodiment of the present invention, a total thickness of the first sealant layer 18, the infusion bag layer 24, and the second sealant layer 20 in the sealed portion 10a is preferably 50 μm or more. That is, the thickness of the infusion bag layer 24 is the thickness of the first resin film 24a+the thickness of the second resin film 24b.

The total thickness of the first sealant layer 18, the infusion bag layer 24, and the second sealant layer 20 in the sealed portion 10a is preferably 50 μm or more, from the viewpoints that, for example, a change in the sealed portion 10a during punching described below is large such that the effect of the present invention is high, and the welding strength between the sealant layer and the infusion bag can be ensured. The welding strength between the sealant layer and the infusion bag increases as the amount thereof melted increases.

The total thickness of the first sealant layer 18, the infusion bag layer 24, and the second sealant layer 20 in the sealed portion 10a is preferably 200 μm or more and more preferably 400 μm or more.

On the other hand, in a case where the total thickness of the first sealant layer 18, the infusion bag layer 24, and the second sealant layer 20 in the sealed portion 10a is excessively large, there may be an inconvenience in that, for example, the amount of gas transmitting through the resin layer between the laminated barrier layer 46 and the metal layer 32 increases such that gas barrier properties of the infusion bag itself decrease, the stiffness of the infusion bag itself increases such that draining properties of an infusion solution decrease, and the infusion bag is not likely to be deformed such that communication is difficult.

In consideration of this point, the total thickness of the first sealant layer 18, the infusion bag layer 24, and the second sealant layer 20 in the sealed portion 10a is preferably 600 μm or less and more preferably 500 μm or less.

In the preparation of the infusion bag 10, first, the infusion bag body 12, the first barrier film 14 including the metal layer 32, the second barrier film 16 including the laminated barrier layer 46, and the first sealant layer 18, and the second sealant layer 20 are prepared.

As described above, the sealant layer is formed of the same material as that of the infusion bag body 12, that is, the first resin film 24a and the second resin film 24b.

Next, the first sealant layer 18 is bonded to the surface of the metal layer 32 of the first barrier film 14. Further, the second sealant layer 20 is bonded to the surface of the protective organic layer 42 of the second barrier film 16.

A method of bonding both of the barrier films and both of the sealant layers is not limited, and a well-known method may be used depending on the material for forming the barrier film, that is, the metal layer 32 and the protective organic layer 42 and the material for forming the sealant layer.

For example, a method using an adhesive can be used. Considering that the sealant layer is a resin film such as PE, PP, or polyvinyl chloride, a two-liquid curable adhesive is preferably used as the adhesive. In particular, a two-liquid curable urethane adhesive (urethane-based adhesive, polyurethane-based adhesive) is more preferably used.

Next, the first sealant layer 18 is disposed to face the infusion bag body 12, and the first barrier film 14 is laminated on one surface of the infusion bag body 12. In this state, by heating and pressing the first barrier film 14, the first barrier film 14 is heat-sealed to the infusion bag body 12 through the first sealant layer 18.

Further, the second sealant layer 20 is disposed to face the infusion bag body 12, and the second barrier film 16 is laminated on the other surface of the infusion bag body 12. In this state, by heating and pressing the second barrier film 16, the second barrier film 16 is heat-sealed to the infusion bag body 12 through the second sealant layer 20.

The heat sealing of the first barrier film 14 through the first sealant layer 18 and/or the heat sealing of the second barrier film 16 through the second sealant layer 20 may be performed on the entire surface of the infusion bag body 12 or may be performed on the sealed portion 10a of an end part in the infusion bag body 12 excluding the accommodation part (bag part) of the content.

Here, in a case where the content of the infusion bag 10 deteriorates due to heat, it is preferable that the heat sealing of the first barrier film 14 through the first sealant layer 18 and the heat sealing of the second barrier film 16 through the second sealant layer 20 are performed only on the sealed portion 10a of the infusion bag body 12.

As a result, the infusion bag 10 including the barrier film for protecting the content on both surfaces is prepared, in which the first barrier film 14 is heat-sealed to one surface of the infusion bag body 12 through the first sealant layer 18, and the second barrier film 16 is heat-sealed to the other surface of the infusion bag body 12 through the second sealant layer 20.

In the infusion bag 10, as shown in FIG. 2 the sealed portion 10a is a laminate where the first barrier film 14, the first sealant layer 18, the infusion bag layer 24, the second sealant layer 20, and the second barrier film 16 are laminated in this order from above in the drawing. Specifically, the infusion bag layer 24 is the first resin film 24a+the second resin film 24b.

In the infusion bag 10, typically, the shape of the infusion bag body 12, the first barrier film 14, the second barrier film 16, the first sealant layer 18, and the second sealant layer 20 is different from the shape of an infusion bag as a product.

Therefore, in the manufacturing of the infusion bag where the barrier film is heat-sealed to both surfaces through the sealant layers, an infusion bag having a desired shape is obtained by cutting the sealed portion 10a of the infusion bag 10 by punching. That is, in the present example, the sealed portion 10a of the infusion bag 10 is a punched portion of an infusion bag according to the embodiment of the present invention.

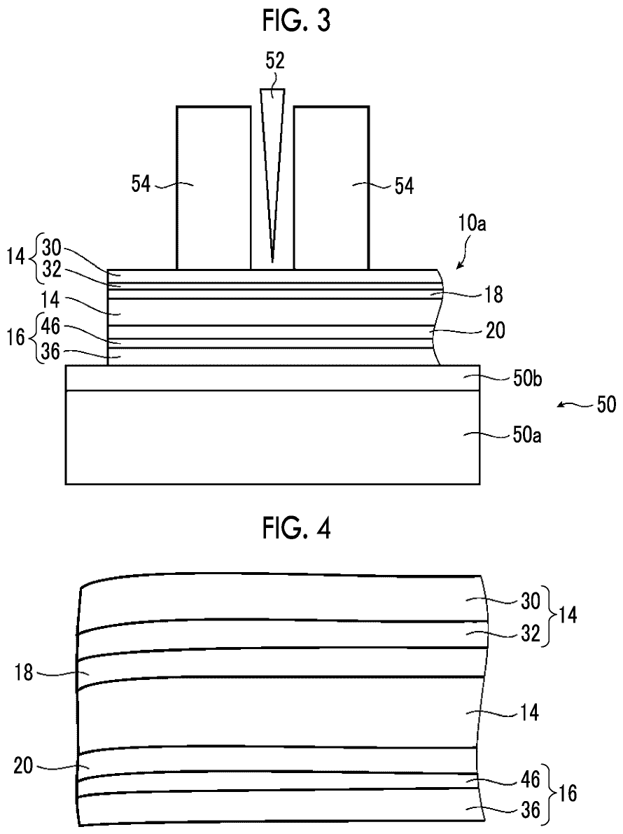

Here, in the manufacturing method according to the embodiment of the present invention, as conceptually in FIG. 3, the infusion bag is in a state where the surface on the second barrier film 16 side including the laminated barrier layer 46 where the inorganic layer 40 exhibits barrier properties is mounted (placed) on a support table 50 (cutting board) for punching.

In addition, the sealed portion 10a of the infusion bag 10 is punched by allowing a cutting blade 52 such as a Thomson blade to cut into the sealed portion 10a in a direction from the first barrier film 14 side toward the second barrier film 16 side.

In the method of manufacturing an infusion bag according to the embodiment of the present invention, with the above-described configuration, an infusion bag where the second barrier film 16 has no breakage, cracking, peeling, and the like, the appropriate inorganic layer 40 is provided, outward exposure of an edge of the metal layer 32 of the first barrier film 14 is suppressed, the protection of the content is excellent, and the safety is also excellent can be stably manufactured.

As also shown in FIG. 3, in a case where the sealed portion 10a of the infusion bag 10 is punched into a desired shape, the sealed portion 10a is placed on the support table 50 that receives the cutting blade 52 and is formed of a hard material such as metal. In addition, the punching of the sealed portion 10a is performed typically in a state where the sealed portion 10a is pressed against the support table 50 by a sealing mechanism 54 such as a sponge. In FIG. 3, for example, the support table 50 has a configuration where a resin plate 50b consisting of hard polycarbonate (PC) is laminated on a surface of a base 50a formed of metal.

Here, as described above, the inorganic layer 40 is generally brittle, in which breakage, cracking, peeling, and the like are likely to occur.

Therefore, in a case where the punching of the infusion bag 10 where the first barrier film 14 including the metal layer 32 as the barrier layer is laminated on one surface and the second barrier film 16 including the laminated barrier layer 46 having the organic-inorganic laminated structure is laminated on the other surface is performed, in order to avoid damage of the inorganic layer 40 side caused by contact with a hard material, the punching is performed in a state where the first barrier film 14 including the metal layer 32 as the barrier layer faces the support table 50 side.

Incidentally, as a result of an investigation, the present inventors found that, in a case where the infusion bag 10 where the first barrier film 14 including the metal layer 32 and the second barrier film 16 including the inorganic layer 40 are heat-sealed through the sealant layer is punched using the above-described punching method in the related art, the inorganic layer 40 is damaged such that a desired barrier performance cannot be obtained, and a sharp edge (end part) of the metal layer 32 is exposed outward.

As described above, in the infusion bag 10, the first barrier film 14 and the second barrier film are heat-sealed to the infusion bag body 12 consisting of the first resin film 24a and the second resin film 24b through the first sealant layer 18 and the second sealant layer 20, respectively.

Accordingly, as shown in FIG. 2, the sealed portion 10a to be punched has the laminated structure where the first barrier film 14, the first sealant layer 18, the infusion bag layer 24, the second sealant layer 20, and the second barrier film 16 are laminated in this order from above in the drawing. Specifically, the infusion bag layer 24 is the first resin film 24a+the second resin film 24b.

As described above, the first resin film 24a and the second resin film 24b forming the infusion bag layer 24, the first sealant layer 18, and the second sealant layer 20 are formed of the same material. That is, the sealed portion 10a is in a state where four resin layers formed of the same material are laminated.

Here, as the material for forming the first resin film 24a and the like, as described above, PE, PP, or polyvinyl chloride is suitably used.

It cannot be said that these materials are hard, and these materials are rather soft materials. In addition, the first resin film 24a and the second resin film 24b forming the infusion bag body 12 need to have a certain degree of thickness in order to ensure a sufficient strength for accommodating the content.

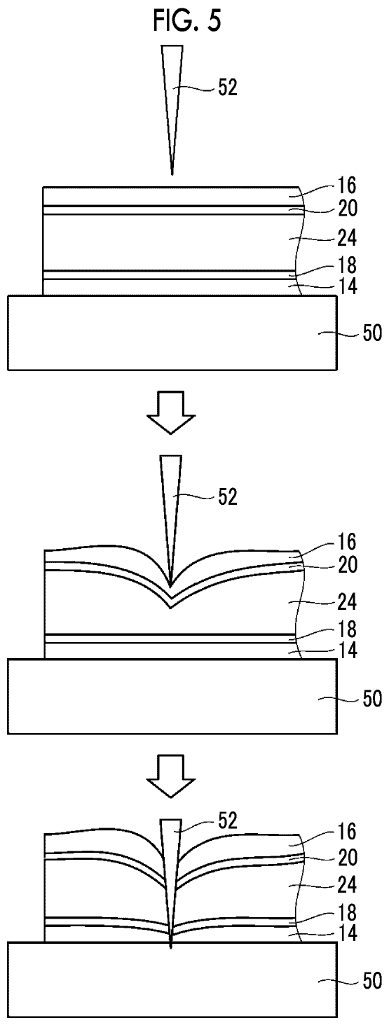

Therefore, in a case where the sealed portion 10a of the infusion bag 10 is punched, as conceptually shown in FIG. 5, the sealed portion 10a is compressed by a blade tip with high precision during cutting with the cutting blade 52 such that a shearing force is generated around the compressed portion and large deformation occurs as shown in the middle stage and the lower stage. In particular, since the infusion bag layer 24 is formed of a soft material and has a certain degree of thickness, this deformation significantly occurs. In addition, as the strength of the infusion bag layer 24 and the sealant layer decreases, this deformation more significantly occurs.

As a result, as in the punching of the sealed portion 10a in the related art, in a case where the cutting blade 52 is allowed to cut into the sealed portion 10a from the second barrier film 16 side including the inorganic layer 40 in a state where the first barrier film 14 faces the support table 50 side, the inorganic layer 40 does not endure the deformation by the cutting blade 52 such that damage such as breakage, cracking, or peeling occur in the inorganic layer 40.

That is, according to an investigation by the present inventors, damage of the inorganic layer 40 caused by the deformation by the cutting blade 52 during the punching of the sealed portion 10a is a much larger problem than the possibility of damage of the inorganic layer 40 side caused by contact with a hard material.

The damage of the inorganic layer 40 in the sealed portion 10a also propagates to the inorganic layer 40 in the accommodation part of the content inside the sealed portion 10a. As a result, the damage of the inorganic layer 40 occurs in the accommodation part of the content. Therefore, in the prepared infusion bag, the second barrier film 16 where the inorganic layer 40 mainly exhibits barrier properties cannot exhibit desired barrier properties, and the content deteriorates.

Further, as shown in the lower stage of FIG. 5, in order to completely cut the sealed portion 10a, the cutting blade 52 needs to be compressed until it cuts the support table 50. In this case, the support table 50 is locally deformed by a pressure during the cutting.

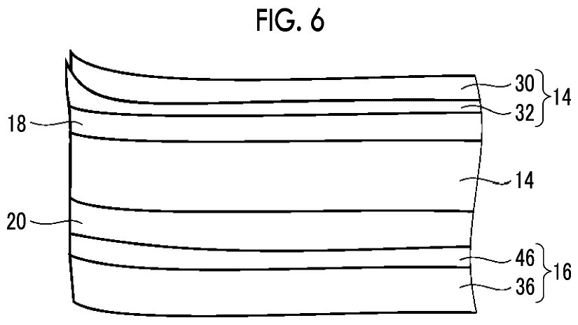

The metal layer 32 is formed of metal such as aluminum and has malleability and ductility. Therefore, due to friction of the periphery of the cut surface with the side surface of the cutting blade 52 in this case, the cut surface of the metal layer 32 of the first barrier film 14 falls toward the support table 50, and a sharp edge of the metal layer 32 is exposed outward as conceptually shown in FIG. 6.

The infusion bag is a container that is used with a hand by a user such as a nurse. Therefore, the sharp edge of the metal is exposed outward, which is dangerous. Therefore, a post treatment for making the edge of the metal layer 32 blunted is further necessary.

On the other hand, in the manufacturing method according to the embodiment of the present invention, during the cutting of the sealed portion 10a of the infusion bag 10 where the first barrier film 14 including the metal layer 32 is heat-sealed to one surface of the infusion bag body 12 through the first sealant layer 18 and the second barrier film 16 including the laminated barrier layer 46 that includes the inorganic layer 40 is heat-sealed to the other surface of the infusion bag body 12 through the second sealant layer 20, in a state where the surface on the second barrier film 16 side is mounted in contact with the support table 50, the cutting blade 52 cuts into the sealed portion 10a from the first barrier film 14 side to punch the sealed portion 10a of the infusion bag 10.

As also shown in FIG. 5, during the punching of the sealed portion 10a, the deformation of the barrier film on the support table 50 side is very small. Therefore, with the manufacturing method according to the embodiment of the present invention, the damage of the inorganic layer 40 caused by the deformation by the cutting blade 52 during the punching of the sealed portion 10a can be significantly suppressed.

That is, in the manufacturing method according to the embodiment of the present invention, even in a case where the total thickness of the infusion bag layer 24, the first sealant layer 18, and the second sealant layer 20 is thick and the strength of these members is low, the deformation of the inorganic layer 40 can be suppressed, and the damage of the inorganic layer 40 can be significantly suppressed.

However, as also shown in FIG. 5, the deformation of the side to be cut by the cutting blade 52 faces downward.

Therefore, in the first barrier film 14 on the side to be cut by the cutting blade 52, as conceptually shown in FIG. 4, the metal layer 32 in the cut surface also falls downward, that is, in a direction toward the sealed portion 10a, and outward exposure of the edge can be significantly reduced.

In the method of manufacturing an infusion bag according to the embodiment of the present invention, with the above-described configuration, an infusion bag where the second barrier film 16 has no breakage, cracking, peeling, and the like, the appropriate inorganic layer 40 is provided, outward exposure of an edge of the metal layer of the first barrier film 14 is suppressed, the protection of the content is excellent, and the safety is also excellent can be stably manufactured.

In the manufacturing method according to the embodiment of the present invention, the punched portion of the sealed portion 10a in the infusion bag 10 to be punched at a time is not limited, and various aspects can be used.

For example, in a case where the shape of the infusion bag 10 is rectangular, in the manufacturing method according to the embodiment of the present invention, one side of the sealed portion 10a may be punched, two sides facing each other may be punched, continuous two sides may be punched, three sides may be punched, or all of the four sides may be punched.

In the manufacturing method according to the embodiment of the present invention, the cutting blade 52 (blade) is not limited, various well-known cutting blades such as a Thomson blade, Pinnacle (registered trademark), or a carving knife can be used.

In addition, the cutting blade 52 may be single-edged or double-edged. However, a single-edged blade is suitably used from the viewpoint that, for example, deformation of the infusion bag after punching is small.

The sealing mechanism 54 that presses the sealed portion 10a against the support table 50 during punching is also not limited, and a well-known sealing mechanism 54 that is used for punching by the cutting blade 52, for example, an elastic member such as a sponge or rubber, or a rigid metal member and a hard resin member connected through a biasing unit such as a spring can be used.

The sealing mechanism 54 typically protrudes from the edge of the cutting blade 52, and is contracted by abutting and being pressed against the sealed portion 10a (object to be punched). Due to the contraction of the sealing mechanism 54, the cutting blade 52 protrudes and cuts into the sealed portion 10a.

The support table 50 on which the sealed portion 10a is placed is also not limited.

Accordingly, as the support table, not only the support table 50 where the resin plate 50b consisting of a hard resin such as PC is laminated on the surface of the base 50a formed of metal as in the example shown in the drawing but also various well-known supporting tables such as a base formed of metal or a base formed of a hard resin such as PC can be used.

Hereinbefore, the method of manufacturing an infusion bag according to the embodiment of the present invention has been described in detail. However, the present invention is not limited to the above-described aspects and various improvements and changes may be made within a range not departing from the scope of the present invention.

### EXAMPLES

Hereinafter, the present invention will be described in detail using Examples. The present invention is not limited to specific examples described below.

### EXAMPLE

### <Infusion Bag Body>

Two low-density polyethylene films (LDPE films) having a rectangular shape with a thickness of 200 μm formed by inflation molding were laminated, and four sides were heat-sealed to obtain an infusion bag body.

### <First Barrier Film>

A PET film having a thickness of 75 μm to which an aluminum layer having a thickness of 20 μm as a metal layer adhered was used.

### <Second Barrier Film>

### <<Support>>

As a support, a polyethylene terephthalate film having a thickness of 100 μm was prepared, and an underlying organic layer, an inorganic layer, and a protective organic layer were formed on a single surface side of the PET film in the following procedure.

### <<Formation of Underlying Organic Layer>>

TMPTA (manufactured by Daicel-Allnex Ltd.) and a photopolymerization initiator (ESACURE KTO 46, manufactured by Lamberti S.p.A.) were prepared and were weighed such that a weight ratio thereof was 95:5. These components were dissolved in methyl ethyl ketone. As a result, a coating liquid (composition for forming an organic layer) having a concentration of solid contents of 15% was obtained.

This coating liquid was applied to the support using a die coater, and was allowed to pass through a drying zone at 50° C. for 3 minutes. Next, while being heated using a backup roll at 80° C., the coating film was irradiated and cured with ultraviolet rays (cumulative irradiation amount: about 600 mJ/cm²). As a result, an underlying organic layer having a thickness of 2 μm was formed on a surface of the support (PET film).

### <<Formation of Inorganic Layer>>

A silicon nitride film having a thickness of 30 nm was formed by plasma CVD as an inorganic layer on the underlying organic layer.

For the formation of the inorganic film, silane gas (flow rate: 160 sccm), ammonia gas (flow rate: 370 sccm), hydrogen gas (flow rate: 590 sccm), and nitrogen gas (flow rate: 240 sccm) were used as raw material gas.

As a power source, a high frequency power supply with a frequency of 13.56 MHz was used, and an input power (plasma excitation power) was 0.8 kW. In addition, a film forming pressure was 40 Pa.

### <<Formation of Protective Organic Layer>

A protective organic layer was formed on the surface of the inorganic layer.

As a coating liquid for forming the protective organic layer, a urethane skeleton acrylate polymer (ACRIT 8BR930, manufactured by Taisei Fine Chemical Co., Ltd.), an additive (VYLON U1510, manufactured by Toyobo Co., Ltd.), and a silane coupling agent (KBM5103, manufactured by Shin-Etsu Silicone Co., Ltd.) were mixed at a ratio of 73.25% to 15% to 10%, 1.75% of a photopolymerization initiator (ESCURE KTO46, manufactured by Lamberti S.p.A.) was added, and the components were dissolved in methyl ethyl ketone to prepare a coating liquid having a concentration of solid contents of 15%.

This coating liquid was applied to the inorganic layer surface using a die coater, and was allowed to pass through a drying zone at 100° C. for 3 minutes. Next, while being wound around a heat roll heated to 60° C., the coating film was irradiated and cured with ultraviolet rays (cumulative irradiation amount: about 600 mJ/cm²) to form a protective organic layer.

As a result, a second barrier film including the underlying organic layer, the inorganic layer, and the protective organic layer on the support (PET film) was prepared.

### <First Sealant Layer and Second Sealant Layer>

As a sealant layer, a low-density polyethylene film (LLDPE film) having a thickness of 40 μm was used.

Using a polyurethane adhesive (main agent: polyester polyol; RU-77T manufactured by Rock Paint Co., Ltd., curing agent: aliphatic isocyanate; H-7, manufactured by Rock Paint Co., Ltd.), a sealant layer was adhered to a surface of the metal layer of the first barrier film and a surface of the protective organic layer of the second barrier film. The thickness of the adhesive layer was set to 3 μm.

As a result, a laminate of the first barrier film and the first sealant layer and a laminate of the second barrier film and the second sealant layer were prepared.

### <Preparation of Infusion Bag>

The first barrier film was laminated on one surface of the infusion bag body such that the first sealant layer faced the infusion bag body side, and the second barrier film was laminated on the other surface of the infusion bag body such that the second sealant layer faced the infusion bag body side. As a result, a laminate was prepared.

By heating and pressing the four sides of the laminate such that the laminate matched the sealed portion in the infusion bag body, the first barrier film was heat-sealed to one surface of the infusion bag body through the first sealant layer, and the second barrier film was heat-sealed to the other surface of the infusion bag body through the second sealant layer. As a result, an infusion bag was prepared.

### <Punching of Sealed Portion of Infusion Bag>

As shown in FIG. 3, by placing the second barrier film side including the inorganic layer on the support table and allowing a Thomson blade to cut into the sealed portion from the first barrier film side including the metal layer to punch the sealed portion, one side of the sealed portion of the prepared infusion bag was punched.

### COMPARATIVE EXAMPLE

During punching of the infusion bag, by placing the first barrier film side including the metal layer on the support table and allowing a Thomson blade to cut into the sealed portion from the second barrier film side including the inorganic layer to punch the sealed portion, one side of the sealed portion of the prepared infusion bag was punched.

### [Evaluation]

### <Damage of Inorganic Layer>

A punched edge surface of the infusion bag was sprayed with a liquid (ageless seal checker manufactured by Mitsubishi Gas Chemical Co., Inc.) that was colored red, and was left to stand for 8 hours. During the standing, the liquid was not vaporized.

Next, by observing a cross section of the punched side, whether or not breakage, cracking, and peeling occurred in the inorganic layer was verified.

As a result, in the infusion bag according to Example that was punched in a state where the second barrier film side including the inorganic layer was placed on the support table, breakage, cracking, and peeling were not able to be verified in the inorganic layer of the punched side.

On the other hand, in the infusion bag according to Comparative Example that was punched in a state where the first barrier film side including the metal layer was placed on the support table, the peeling of the inorganic layer was verified.

### <Exposure of Edge of Metal Layer>

The entire area of the punched side of the infusion bag was slid into contact with a Vienna sausage simulating a fingertip once to verify whether or not the Vienna sausage was damaged.

As a result, in the infusion bag according to Example that was punched in a state where the second barrier film side including the inorganic layer was placed on the support table, the damage of the Vienna sausage was not verified, and it was verified that the edge of the metal layer was not exposed outward.

On the other hand, in the infusion bag according to Comparative Example that was punched in a state where the first barrier film side including the metal layer was placed on the support table, the Vienna sausage was damaged, and it was verified that the edge of the metal layer was exposed outward.

From the above results, the effects of the present invention are obvious.

The present invention is suitably applicable to manufacturing of various infusion bags.

### EXPLANATION OF REFERENCES

10: infusion bag
12: infusion bag body
14: first barrier film
16: second barrier film
18: first sealant layer
20: second sealant layer
24: infusion bag layer
30, 36: support
32: metal layer
38: underlying organic layer
40: inorganic layer
42: protective organic layer
46: laminated barrier layer
50: support table
50a: base
50b: resin plate
52: cutting blade
54: scaling mechanism

What is claimed is:

1. A method of manufacturing an infusion bag, the method comprising:
punching an infusion bag where a barrier film is bonded to both surfaces of an infusion bag body through a sealant layer,
wherein in a punched portion of the infusion bag, a first barrier film, a first sealant layer, an infusion bag layer, a second sealant layer, and a second barrier film are laminated in this order,
the first barrier film includes a metal layer as a barrier layer, and the second barrier film includes a laminated barrier layer having a configuration where an organic layer and an inorganic layer are laminated, and
in a state where the punched portion of the infusion bag is mounted on a support table for punching such that a surface on the second barrier film side is in contact with the support table for punching, the infusion bag is punched by allowing a blade to cut into the infusion bag in a direction from the first barrier film toward the second barrier film side.

2. The method of manufacturing an infusion bag according to claim 1,
wherein the first barrier film includes a support and a metal layer having a thickness of 50 μm or less that is laminated on the support.

3. The method of manufacturing an infusion bag according to claim 1,
wherein the metal layer of the first barrier film is an aluminum layer.

4. The method of manufacturing an infusion bag according to claim 1,
wherein a total thickness of the first sealant layer, the infusion bag layer, and the second sealant layer is 50 μm or more.

5. The method of manufacturing an infusion bag according to claim 1,
wherein a material for forming the first sealant layer, the infusion bag layer, and the second sealant layer is any one of polypropylene, polyethylene, or polyvinyl chloride.

6. The method of manufacturing an infusion bag according to claim 1,
wherein the second barrier film includes a support and the laminated barrier layer that is laminated on the support.

7. The method of manufacturing an infusion bag according to claim 6,
wherein the support is a polyethylene terephthalate film.

8. The method of manufacturing an infusion bag according to claim 6,
wherein a thickness of the support is 50 μm or more.

9. The method of manufacturing an infusion bag according to claim 1,
wherein the laminated barrier layer includes one or more laminated structures of an underlying organic layer and an inorganic layer and a protective organic layer that is an upper most layer.

10. The method of manufacturing an infusion bag according to claim 2,
wherein the metal layer of the first barrier film is an aluminum layer.

11. The method of manufacturing an infusion bag according to claim 2,
wherein a total thickness of the first sealant layer, the infusion bag layer, and the second sealant layer is 50 μm or more.

12. The method of manufacturing an infusion bag according to claim 2,
wherein a material for forming the first sealant layer, the infusion bag layer, and the second sealant layer is any one of polypropylene, polyethylene, or polyvinyl chloride.

13. The method of manufacturing an infusion bag according to claim 2,
wherein the second barrier film includes a support and the laminated barrier layer that is laminated on the support.

14. The method of manufacturing an infusion bag according to claim 13,
wherein the support is a polyethylene terephthalate film.

15. The method of manufacturing an infusion bag according to claim 7,
wherein a thickness of the support is 50 μm or more.

16. The method of manufacturing an infusion bag according to claim 2,
wherein the laminated barrier layer includes one or more laminated structures of an underlying organic layer and an inorganic layer and a protective organic layer that is an upper most layer.

17. The method of manufacturing an infusion bag according to claim 3,
wherein a total thickness of the first sealant layer, the infusion bag layer, and the second sealant layer is 50 μm or more.

18. The method of manufacturing an infusion bag according to claim 3,
wherein a material for forming the first sealant layer, the infusion bag layer, and the second sealant layer is any one of polypropylene, polyethylene, or polyvinyl chloride.

19. The method of manufacturing an infusion bag according to claim 3,
wherein the second barrier film includes a support and the laminated barrier layer that is laminated on the support.

20. The method of manufacturing an infusion bag according to claim 19,
wherein the support is a polyethylene terephthalate film.
